(19) United States
(12) Patent Application Publication
(10) Pub. No.: US 2011/0215911 A1
(43) Pub. Date: Sep. 8, 2011

(54) Method and system for monitoring data of personnel

(76) Inventors: Troy Cassels, Pasadena, TX (US); William Berry, Houston, TX (US)

(21) Appl. No.: 12/660,803

(22) Filed: Mar. 4, 2010

(51) Int. Cl. G01K 7/01

(52) U.S. Cl. 340/10.4

(57) ABSTRACT

A method and system (100) for monitoring productivity of employees in an enterprise. An identification device (102) is associated with an employee of the enterprise. The identification device (102) is configured to send signals to a reader (104). The reader (104) is associated with an area in the enterprise. When the employee enters the area and exits the area, the identification device (102) sends the signals to the reader (104). The reader (104) is configured to send the received signals to a processor (106) through a transmission system. The processor (106) processes the received signals to determine information related to time spent by the employee in the area. The processor (106) stores the information together with a pre-defined workflow schedule. Further, the processor (106) compares the information and the pre-defined workflow schedule to generate a report (208). The processor (106) stores the report (208) for later retrieval. The report (208) provides the details related to the productivity of the employee and is stored in the processor (106).

### FIELD OF THE INVENTION

This disclosure in general relates to monitoring productivity of personnel in an enterprise, and more specifically, to generating and storing productivity and related reports of an employee wherein monitoring the productivity of personnel is conducted by using identification devices, such as Radio Frequency Identification (RFID) Tags, that are associated with personnel.

### BACKGROUND OF THE INVENTION

Due to increasing competition, organizations look for various ways to decrease labor costs. Organizations need to keep track of productivity of its employees so that better management of resources can be done. Further, the organization needs to monitor, whether the work is done in a sequential manner and the percentage of work completed by the employees in an allocated time. Furthermore, logging details such as the list of activities employees need to complete in the organization, time spent by the employees in a specific area of the organization of each personnel, such as a contractor, manager, worker, guest, etc, also has to be maintained.

Traditionally, productivity measurement was done manually. Registers were used to maintain a log of personnel entering and exiting the work premises. Data gathered from the registers was then used to generate various reports, which included productivity reports, and efficiency reports.

With advances in technology, various tagging systems and tracking systems have been developed to keep a track on personnel movements across various departments in an enterprise. For example, wireless tags and readers have been used to monitor the personnel entering and exiting a particular department, as described in U.S. Pat. Nos. 7,123,149 and 7,336,181.

Systems have been developed for real-time dispatching of employees of an enterprise to an area in the enterprise where an activity has to be performed. Radio Frequency Identification (RFID) tags are carried by the employees, and RFID receivers are placed at various locations in the enterprise, to communicate with the RFID tags. Based on the information received from the RFID receivers, employees are sent to the area in the enterprise where some activity has to be performed. This system is disclosed in US Patent publication 2007/0100677.

While various methods and systems have been developed, there exists a need to keep a track on the amount of work done by an individual worker by automated techniques, so that better resource management can be done in an enterprise. There is also a need to synchronize the planned schedule of the activities and the work completed by the employees. Thus a need persists for further contributions in this area of technology.

### SUMMARY OF THE INVENTION

This application is directed to a system for monitoring productivity of employees in an enterprise by using a Radio Frequency Identification (RFID) tag carried by an employee, the RFID tag is configured to uniquely identify the employee. A reader receives signals from the RFID tag and further transmits the signals to a processor. The reader is associated with a physical area of the enterprise. The processor processes the signals received from the reader to determine the time spent by the employee at the area. The processor then generates at least one report by comparing the processed signals and a Critical Path Method (CPM) schedule of the enterprise. The report provides details related to the productivity of the employee. The report is then stored in the processor for later retrieval.

### BRIEF DESCRIPTION OF THE FIGURES

The accompanying Figures, where like reference numerals refer to identical or functionally similar elements throughout the separate views, and which, together with the detailed description below, are incorporated in and form a part of the specification, serve to further illustrate various embodiments and to explain various principles and advantages, all in accordance with the present invention.

FIG. 1 shows a block diagram of an exemplary enterprise wherein certain of the embodiments of the present disclosure can be practiced;

FIG. 2 is a block diagram illustrating a plurality of inputs to a processor and an output generated from the processor, in accordance with one embodiment of the present disclosure;

FIG. 3 is a block diagram depicting the components of the processor, in accordance with one embodiment of the present disclosure; and

FIG. 4 is a flow diagram depicting a method of monitoring productivity of employees in an enterprise, in accordance with one embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION

Before describing in detail the particular method and system for monitoring productivity of employees in an enterprise, in accordance with various embodiments of the present disclosure, it should be observed that the present disclosure resides primarily in combinations of method steps related to the method and system for monitoring productivity of employees in an enterprise. Accordingly, the apparatus components and method steps have been represented, where appropriate, by conventional symbols in the drawings, showing only those specific details that are pertinent to an understanding of the present disclosure, so as not to obscure the disclosure with details that will be readily apparent to those with ordinary skill in the art, having the benefit of the description herein.

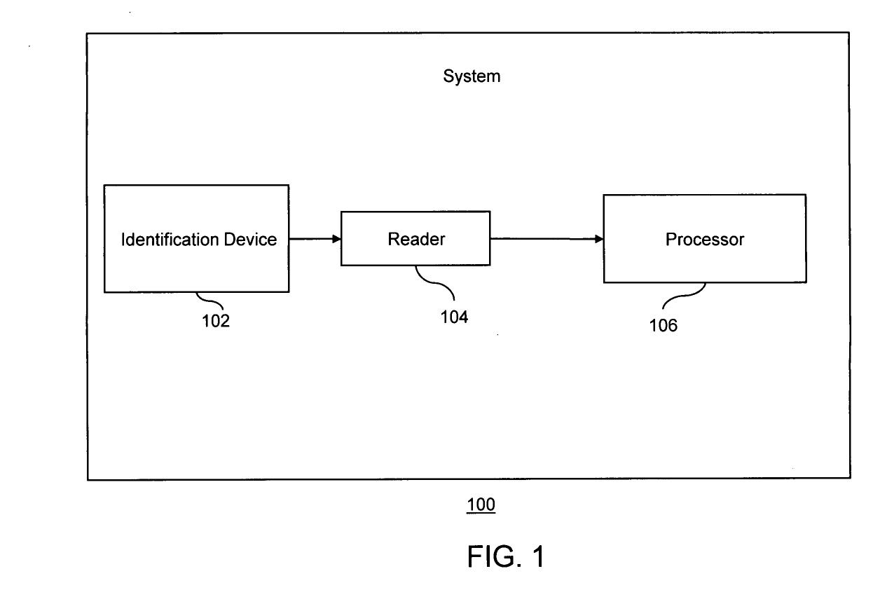

FIG. 1 shows a system 100 where certain embodiments of the present disclosure can be practiced. The system 100 is installed in an enterprise, where the productivity of employees of the enterprise needs to be monitored. The enterprise can be an assembly plant, a refinery, a chemicals plant, a power plant, and the like. It can be appreciated that the system 100 can be installed in any kind of enterprise. For the purpose of illustration, the system 100 can be a power generation set-up and is shown to include an identification device 102, a reader 104, and a processor 106.

Examples of the identification device 102 can include, but are not limited to, a Radio Frequency Identification (RFID) tag, an infrared tag, and a Bluetooth tag.

RFID technology can be employed to monitor the movement of employees in the enterprise. RFID technology comprises a RFID tag, and a RFID reader. Generally, RFID tags can contain one or more coils to serve as an antenna, and a microchip, containing a radio transceiver. The microchip may also store data, such as a unique identification number for identifying an object with which the RFID tag is associated. Additionally, RFID tags may be classified as passive or active. Passive RFID tags generally do not transmit any information stored within the RFID tag until activated by an RFID reader. Active RFID tags, on the other hand, may constantly transmit information stored on the microchip to the RFID reader.

RFID readers may have the same basic components as the RFID tags, including an antenna and reader electronics. The RFID reader performs several functions. In some systems, a reader may produce a low-level radio frequency (RF) magnetic field generated by the reader antennas. The magnetic field may broadcast activation codes, which may trigger RFID tags in the vicinity of the reader to start communicating with the RFID readers. When a passive RFID tag is carried within range of the magnetic field generated by the RFID reader, the antenna in the RFID tag may collect the field energy from the magnetic field and use it to power the microchip on the RFID tag. Passive RFID tags may use this captured field energy to transmit data stored on the microchip. The RFID reader receives the information transmitted from the RFID tag, whereupon the RFID reader may store the information or transmit the information to a device for processing. It can be appreciated that the RFID tag and RFID reader can communicate wirelessly. Further, the processing device can be located remotely and the RFID reader can communicate with the processing devices by using a wired or a wireless mode of communication. Examples of RFID to use with the present invention include but are not limited to those as found on intermec.com and website: www.atlasrfidstore.com, or as produced by manufacturers such as Gao RFID, Motorala, and ITEC.

Each employee of the enterprise can be associated with an identification device such as 102 to uniquely identify the employee. The identification device 102 is associated with an employee of the enterprise. The employee can be a worker, a contractor, a supervisor etc. The employee of the enterprise carries the associated identification device 102, and for purposes of the invention maintains the identification device 102 on his/her person at all times. The device 102 may be associated with a multipurpose device wherein the device also includes an identification badge, an electronic key or entry, a monitoring sensor, and the like. When the employee enters an area associated with the reader 104, the reader 104 starts communicating with the associated identification device 102. As and when the employee enters into the area and exits from the area, the reader 104 receives the signals, from the associated identification device 102, indicating the entry of the employee in the area and exit of the employee from the area, respectively. In an embodiment the signals received by the reader 104 are transmitted to the processor 106, through a transceiver (not shown in the Figure). The processor can be communicably coupled to the reader 104 by using a wired or wireless mode of communication. The processor 106 processes the signals received from the reader 104 to determine information related to the time spent by the employee in the area. Thereafter, the processor 106 generates a report by comparing the determined information and a pre-defined workflow schedule, wherein the report provides details related to the productivity of the employee. The detailed description of the functioning of processor 106 has been explained in subsequent sections of description. Examples of processors which may be employed include but are not limited to Toadfly Technologies DMT (Data Monitor Tool).

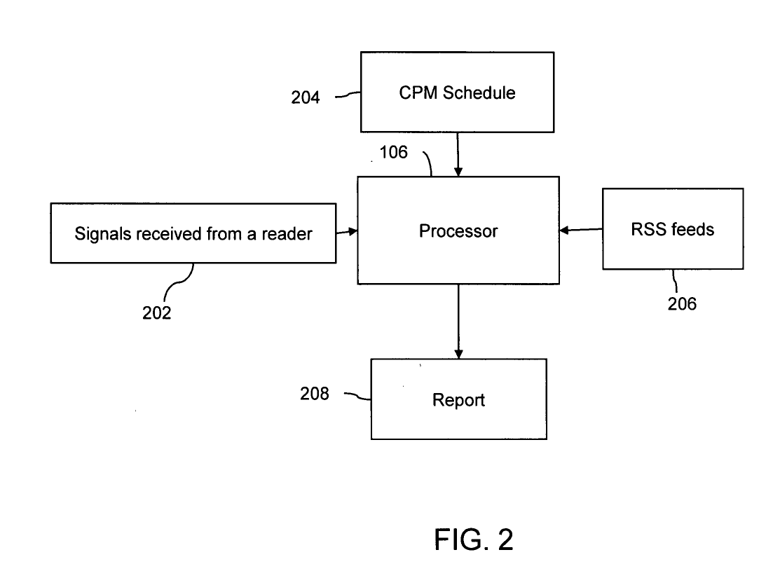

FIG. 2 is a flow diagram showing a plurality of inputs to the processor 106 and an output generated from the processor 106, in accordance with one embodiment of the present disclosure. The processor 106 generates at least one report by comparing a plurality of inputs and stores the at least one report for later retrieval. The plurality of inputs includes, but is not limited to, signals received from the reader 202, a Critical Path Method (CPM) schedule 204 of the enterprise, and a Really Simple Syndication (RSS) feed 206. The RSS feed 206 can provide updated information related to activities that have to be performed by the employee. Consider a scenario, in which predefined order of completing certain activities has to be rescheduled due to some unforeseen circumstance. Information can be obtained from the schedule, the network, or through an external memory or apparatus source such as an external hard drive. The RSS feed 206 can provide the updated information related to the activities in such scenarios. In another embodiment, the plurality of inputs can include time tracking information (not shown in the Figure). The time tracking information is the duration of time spent by each employee at various locations in an enterprise.

Further, the processor 106 is configured to receive and store the plurality of inputs. The signals 202 received from the reader 104 are stored and processed to determine information related to time spent by the employee in the area. The processed information is also stored in the processor 106.

Furthermore, the processor is configured to receive the CPM schedule 204 as an input. The CPM schedule 204 is a method for scheduling the lists of task and activities for a project and is used for effective project management. The CPM schedule 204 includes a list of all tasks required to complete a project. The CPM schedule 204 also includes time needed to complete each task of the project. In addition, the CPM schedule 204 includes the relation such as sequence in which each task has to be completed. In other words, the CPM schedule 204 is pre-defined workflow schedule for a project. In an embodiment a CPM schedule can also be developed for each employee, thereby providing a workflow schedule of activities to be performed by an employee.

Thereafter, the received signal 202 is compared with the CPM schedule 204 to generate the report 208. The report 208 provides details related to the productivity of employee. The report 208 can be at least one of a productivity report, a base report, a variable report, and an efficiency report. For the purpose of this description the at least one report is illustrated as productivity report 208. In other words, the productivity report 208 compares the time spent by the employee to complete each activity and the pre-defined time, according to the pre-defined workflow schedule, that was required to complete each activity. Thus, the productivity report 208 details the productivity of the employee in completing each activity. The report 208 may be obtained from a web based database, networked database or through an associated peripheral device.

For better understanding consider a scenario where the processor 106 is installed with the system 100 in a power generation set-up of an enterprise. In this scenario, an employee is appointed to maintain the boiler of the power generation set-up. Further, a plurality of readers, similar to the reader 104, is installed at various locations in the power generation set-up. Furthermore, the employee carries an RFID tag similar to the identification tag 102.

In this scenario, when the employee carrying the RFID tag enters a boiler area of the power generation set-up, a reader installed at entrance of the area communicates with the RFID tag. Thereafter, the reader transmits the information related to the time and location of the RFID tag to the processor 106, thereby identifying the presence of the unique employee associated with the tag in the vicinity of the boiler area of the power generation set-up. Further, the employee exits from the boiler area to enter the generator area. The reader installed at the entrance of the boiler area notifies the exit of the employee from the boiler area. Furthermore, a reader installed at the generator area notifies the entrance of the employee in the generator area. Thus, tracking the time of the entrance and exit of the employee in the boiler area provides the time spent by the employee in an inspection of the boiler. This time tracking information is communicated to the processor 106 by the reader installed at the boiler area. Similarly, the reader installed at the generator area provides the time tracking information to the processor 106. It is to be understood that the multiple entries and exist from an area are reported to the processor 106 by each reader of the plurality of the readers.

Thereafter, a CPM schedule related to the maintenance of the power generation set-up is fed as an input to the processor 106. The CPM schedule may include various tasks such as checking the temperature and pressure values at various points, removing some waste materials from a component of a boiler area, repairing a component of the boiler, repairing fluid conduits in the boiler area. The processor 106 compares the time tracking information and the CPM schedule to determine the productivity of the employee. In the above scenario, if the time spent by the employee during the inspection of the boiler is more than the time allocated as per the CPM schedule then a report listing the productivity of the employee can be generated by the processor. It should be appreciated that a report can be generated even if the time spent by the employ is less or equal to the allocated time as per the CPM schedule.

In another embodiment, a Program Evaluation and Review Technique (PERT) schedule of the enterprise is an input to the processor 106. The PERT schedule can be used to analyze activities that have to be performed to complete a task and the time duration to complete each activity of the task. The PERT schedule can also be used to identify the minimum time needed to complete the project. Further, the PERT schedule can provide various time estimates to complete an activity. For example, the PERT schedule can provide an optimistic time estimate, a normal time estimate, and a pessimistic time estimate to complete an activity. On the basis of the various times estimates, an expected time needed to complete an activity can be computed. The PERT schedule also takes in to consideration any risks or uncertainties that may encountered during the project.

The PERT schedule is taken as an input and a comparison of the PERT schedule and the time spent information received from the reader 104 for an employee is done by the processor 106. Thereafter the report 208 is generated based on the comparison of the PERT schedule and the time spent information.

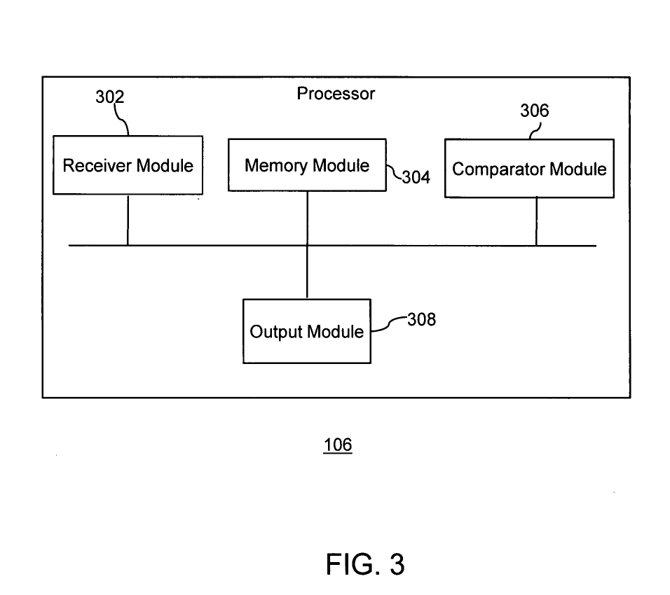

FIG. 3 is a block diagram illustrating the components of the processor 106, in accordance with one embodiment of the present disclosure. The processor 106 is shown to include a receiver module 302, a memory module 304, a comparator module 306, and an output module 308. The receiver module 302 is configured to receive the signals from the reader 104. The signals from the reader 104 are received through a transceiver (not shown). Further, the received signals are processed by the processor 106 to determine the information contained in the received signal. The information provides the details related to the time spent by the employee in the area. Thereafter, the information determined by processing the signals is stored in the memory module 304. All components described above may be purchased or located at any RFID distribution center.

Furthermore, the memory module 304 is configured to store the pre-defined workflow schedule. The pre-defined workflow schedule includes a series of tasks and activities that need to be executed by any personnel of the enterprise. For example, the pre-defined workflow schedule can include time and motion study of each step of the task and activities that needs to be completed. For the purpose of illustration, the pre-defined workflow schedule is a Critical Path Method (CPM) schedule 204 of the enterprise, and Really Simple Syndication (RSS) feeds 206. In an embodiment of the disclosure, the pre-defined workflow schedule can be a Program Evaluation and Review Technique (PERT) schedule of the enterprise.

The comparator module 306 is configured to compare the stored information and the pre-defined workflow schedule. In other words, the comparator module 306 takes one of the input as the time spent by the employee in an area by tracking the entry and exit of the employee for an area in the enterprise. The time spent by the employee in the area is compared with the pre-defined workflow schedule. Thereafter, the output module 308 is configured to generate the at least one report. Further, the at least one report is stored in the processor 106 for later retrieval.

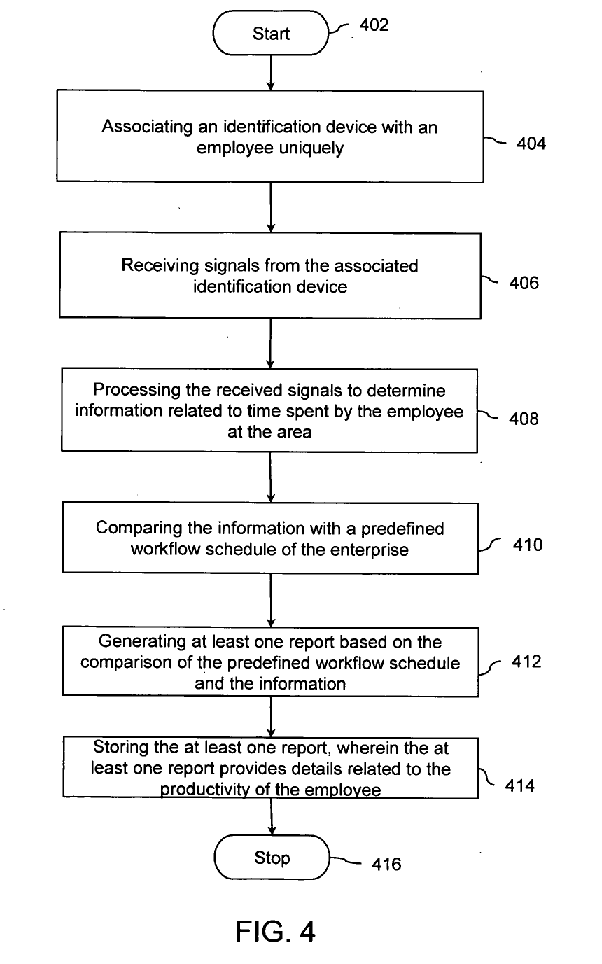

FIG. 4 is a flow diagram illustrating a method for monitoring productivity of employees of an enterprise, in accordance with one embodiment of the present disclosure. The following method will be explained with reference to FIG. 1 and FIG. 2. The method for monitoring productivity is initiated at step 402. At step 404, the identification device 102 is associated with an employee uniquely, wherein the employee carries the associated identification device 102. Preferably the identification device is associated with an employee entry badge issued by the organization or governmental entity. The associated identification device 102 can be a RFID tag, an infrared red, a Bluetooth tag and the like. The associated identification device 102 is configured to send signals to the reader 104. At step 406, the reader 104 receives the signals from the identification device 102. The reader 104 is associated with an area in the enterprise. In other words, the reader 104 communicates with the associated identification device 102, when the employee carrying the associated identification device 102 is physically present in the area. The signals received from the associated identification device 102 indicate the entry of the employee in an area and exit of the employee from the area. At step 408, the signals received from the reader 104 are processed by the processor 106 to determine information related to time spent by the employee at the area.

In an embodiment, a transceiver is configured to transfer the signals from the reader 104 to the processor 106. The transceiver can be Wireless Fidelity (Wi-Fi) system, a communication cable, a category 5e communication line and the like. In an alternative embodiment the signals are transferred from the reader 104 to the processor 106 by using a suitable mode of communication.

The information related to time spent by the employee at the area and the pre-defined workflow schedule is stored in the memory module 302. The pre-defined workflow schedule can include, but is not limited to, Critical Path Method (CPM) schedule 204 of the enterprise, Really Simple Syndication (RSS) feeds 206, Program Evaluation and Review Technique (PERT) schedule, and a planned work activity schedule for employees. At step 410, the pre-defined workflow schedule is compared with the information related to time spent by the employee at the area. The pre-defined schedule contains the details of various activities and the time needed to complete the various activities. The pre-defined schedule can also contain the details of the type of craftsman needed to complete a particular activity. At step 412, the report 208 can be generated, wherein the report 208 is based on the comparison of the pre-defined workflow schedule and the information related to time spent by the employee. The report can provide the details of the productivity of employees. The report 208 can be at least one of a productivity report, a base report, a variable report, and an efficiency report. At step 414, the report 208 can be stored in the processor 106. The report 208 can be used to study the productivity of the employee. Thereafter, the method terminates at step 416.

For better understanding consider an exemplary embodiment, where a house keeping manager has to measure the productivity of an employee in an organization. Multiple readers are installed at different departments of the organization. Each reader of the plurality of readers is associated with the department where it has been installed. An identification device is associated with the employee of an enterprise. The identification device can be similar to the identification device 102 and is unique for the employee. In other words, each employee of the organization has a unique identification tag. When the employee carrying the associated identification device enters a first department in the organization, the signals transmitted from the identification device are received by the reader installed in the first department. In a similar manner each reader of the plurality of reader receives the signals from the identification device when the employee enters the corresponding department of the reader. Further, each reader of the plurality of the readers sends the signals to a processor through a transceiver. The signal sent by the processor includes information related to the time spent by the employee in the department of the organization. Thereafter, the processor 106 receives the signals from the readers and processes the received signals to determine the details related to the time spent by the employee in every department of the organization where employee was physically present. For example, the processor 106 determines which employee was present in which department during a given time period. Thereafter, a pre-defined workflow schedule is stored in the processor. The pre-defined workflow schedules contain the details of timelines of various activities that have to be completed in the various departments of the organization. The activities can be routine maintenance, installing or removing equipment and materials or general industrial activities. The processor compares the pre-defined workflow schedule and the information related to time spent by the employee to generate a report. The report generated by the processor can be stored in the processor for observing the productivity of the employee. The report provides a comparison of the time spent by the employee to complete the various activities and the timelines of each activity. Thus the report can be used to judge the productivity and efficiency of the employees. Further the report can be used to rank the employees according to their productivity.

The disclosed methodology may be executed by using a computer system having a processor implementing a computer program product. Such implementation may include a series of computer programs and instructions saved either on a tangible medium, such as a computer readable medium (e.g., a computer diskette, hard disk, CD-ROM, ROM, or flash memory device) or transmittable to a computer system, via a suitable mode of communication such as modem or a communications adapter connected to a network over a medium. Such instructions may be stored in memory units, such as optical or other memory devices, magnetic storage devices, and may be transmitted using any communications technology, such as electromagnetic waves, or other transmission technologies. Further, the series of computer instructions embodies all or part of the functionality previously described herein with respect to the system. Those skilled in the art should appreciate that such computer instructions can be written in a number of programming languages for use with many computer architectures or operating systems. It is expected that such a computer program product may be distributed as a removable medium with accompanying printed or electronic documentation. Furthermore, some embodiments of the invention may be implemented as a combination of both software (e.g., a computer program product) and hardware. Still other embodiments of the invention are implemented as entirely hardware.

The present disclosure, along with methods and systems, are representative of preferred embodiments. They are exemplary embodiment and are not intended as limitations on the scope of the present invention. Changes therein and other uses will occur to those skilled in the art which are encompassed within the spirit of the invention as defined by the scope of the appended claims.

What is claimed is:

1. A system for monitoring productivity of employees in an enterprise, comprising:
an identification device carried by an employee and configured to uniquely identify the employee;
a reader associated with an area in the enterprise and configured to receive signals from the identification device, the signals indicating the entry of the employee in the area and exit of the employee from the area; and
a processor operatively coupled to the reader and configured to store and process the signals received from the reader and generate at least one report based on the processed signals and a pre-defined workflow schedule of the enterprise, wherein the at least one report provides details related to the productivity of the employee.

2. The system according to claim 1, wherein the pre-defined workflow schedule is at least one of a Critical Path Method (CPM) schedule, a Program Evaluation and Review Technique (PERT) schedule, a planned work activity schedule for employees, and Really Simple Syndication (RSS) feeds.

3. The system according to claim 1, wherein the at least one report is generated based on information obtained from a time tracking system of the enterprise.

4. The system according to claim 1, wherein the identification device is at least one of a Radio Frequency Identification (RFID) tag, an infrared tag, and a Bluetooth tag.

5. The system according to claim 1, further comprising a transceiver, wherein the transceiver is configured to transmit the received signals from the reader to the processor.

6. The system according to claim 1, wherein the at least one report is at least one of a productivity report, a performance report, an efficiency report, a base report, and a variable report.

7. The system according to claim 1, wherein the processed signals indicate the time spent by the employee at the area.

8. The system according to claim 1, wherein the enterprise is one or more of an assembly plant, power generation set-up, a refinery, a chemicals plant, and a power plant.

9. A system for monitoring productivity of employees in an enterprise, comprising:
a Radio Frequency Identification (RFID) tag carried by an employee and configured to uniquely identify the employee;
a reader associated with an area in the enterprise and configured to receive signals from the RFID tag, the signals indicating the entry of the employee in the area and exit of the employee from the area; and
a processor operatively coupled to the reader, the processor configured to process the signals received from the reader to determine the time spent by the employee at the area and generate at least one report by comparing the processed signals and a Critical Path Method (CPM) schedule of the enterprise, wherein the at least one report provides details related to the productivity of the employee.

10. The system according to claim 9, further comprising a transceiver, the transceiver configured to transmit the received signals from the reader to the processor;

11. The system according to claim 10, wherein the processor further comprises:
a receiver module, the receiver module configured to receive the received signals through the transceiver and process the received signals;
a memory module, the memory module configured to store the CPM schedule and the processed signal;
a comparator module, the comparator module configured to compare the processed signals and the CPM schedule; and
an output module, the output module configured to generate the at least one report based on the comparison.

12. The system according to claim 9, wherein the at least one report is at least one of a productivity report, a performance report, an efficiency report, a base report, and a variable report.

13. A method for monitoring productivity of employees of an enterprise, the method comprising the steps of:
associating an identification device with an employee uniquely, wherein the employee carries the associated identification device;
receiving signals from the associated identification device, wherein the signals indicate the entry of the employee in an area and exit of the employee from the area;
processing the received signals to determine information related to time spent by the employee at the area;
comparing the information with a pre-defined workflow schedule of the enterprise;
generating at least one report based on the comparison of the workflow schedule, and the information; and
storing the at least one report, wherein the at least one report provides details related to the productivity of the employee.

14. The method according to claim 13, wherein the at least one report is at least one of a productivity report, an efficiency report, a performance report, a base report, and a variable report.

15. The method according to claim 13, wherein the pre-defined workflow schedule is at least one of a Critical Path Method (CPM) schedule, a Program Evaluation and a Review Technique (PERT) schedule, a planned work activity schedule for employees, and Really Simple Syndication (RSS) feeds.

16. The method according to claim 13, wherein the identification device is at least one of a Radio Frequency Identification (RFID) Tag, an infrared tag, and a Bluetooth tag.

17. The method according to claim 13 wherein the at least one report is generated based on information obtained from a time tracking system of the enterprise.
